(19) United States
(12) Patent Application Publication
(10) Pub. No.: US 2005/0131754 A1
(43) Pub. Date: Jun. 16, 2005

(54) System and method for estimating the feasibility of outsourcing information technology services

(75) Inventors: James T. Chapman, Portland, OR (US); Paul A. Below, Poulsbo, WA (US); Ernie Zenoniani, Littleton, CO (US); Olga Makar-Limanov, West Bloomfield, MI (US)

Correspondence Address: BAKER BOTTS L.L.P., 2001 ROSS AVENUE, 6TH FLOOR, DALLAS, TX, 75201, US

(73) Assignee: Electronic Data Systems Corporation

(21) Appl. No.: 10/735,542

(22) Filed: Dec. 12, 2003

(51) Int. Cl. G06F 17/60

(52) U.S. Cl. 705/10

(57) ABSTRACT

In one embodiment, a computer-implemented method for estimating the feasibility of outsourcing information technology services includes extracting at least a portion of a first set of empirical data associated with one or more software applications in a historical portfolio. The historical portfolio contains software applications utilized by a client. The method also includes aggregating at least a portion of the extracted data, creating a statistical model of the historical portfolio based on the first set of data, and generating a simulated portfolio based on the statistical model. The method further includes generating a cost estimate associated with outsourcing technology services based on the simulated portfolio and a second set of data. At least a portion of the second set of data contains empirical data containing data and assumptions relating to the historical portfolio. The method also includes determining the feasibility of outsourcing technology services based on the cost estimate.

### TECHNICAL FIELD OF THE INVENTION

This invention relates generally to a system and method for estimating the costs and resources required to manage information technology applications, and more particularly to a system and method for estimating the feasibility of outsourcing information technology services.

### BACKGROUND OF THE INVENTION

The ability of a company to make a profit on the services that it provides to its customers is based largely on the company's ability to accurately price those services. This is especially true in the new business and sales engagement process of information technology (IT) services that are centered on long-term software application management and maintenance of a client's software application portfolios. Conventional project cost estimation methods utilize qualitative and/or experienced-based data. For example, conventional estimation techniques assess the client's current level of IT support and use that information to make experience-based estimations of what level of support the client will require in the future. However, these estimates often result in highly subjective estimates that are more indicative of past experiences than predictive of the costs of the current project.

### SUMMARY OF THE INVENTION

In one embodiment, a computer-implemented method for estimating the feasibility of outsourcing information technology services includes extracting at least a portion of a first set of empirical data associated with one or more software applications in a historical portfolio. The historical portfolio contains software applications utilized by a client. The method also includes aggregating at least a portion of the extracted data, creating a statistical model of the historical portfolio based on the first set of data, and generating a simulated portfolio based on the statistical model. The method further includes generating a cost estimate associated with outsourcing technology services based on the simulated portfolio and a second set of data. At least a portion of the second set of data contains empirical data containing data and assumptions relating to the historical portfolio. The method also includes determining the feasibility of outsourcing technology services based on the cost estimate.

In another embodiment, software for estimating the feasibility of outsourcing information technology services is embodied in a computer readable medium and comprises computer code such that when executed is operable to extract, based on one or more selection criteria, at least a portion of a first set of empirical data associated with one or more software applications in a historical portfolio. The historical portfolio contains software applications utilized by a client. The code is also operable to aggregate at least a portion of the extracted data, create a statistical model of the historical portfolio based on the first set of data, and generate a simulated portfolio based at least in part on the statistical model. The code is further operable to generate a cost estimate associated with outsourcing technology services based at least in part on the simulated portfolio and a second set of data. At least a portion of the second set of data contains empirical data, the empirical data containing data and assumptions relating to the historical portfolio. The code is also operable to determine the feasibility of outsourcing technology services based at least in part on the cost estimate.

Technical advantages of one or more embodiments of the present invention may include the ability to provide an automated feasibility estimation process that utilizes empirical data to predict the costs of outsourcing information technology services. Another technical advantage of one or more embodiments of the present invention may include the ability to provide an accurate cost estimate for outsourcing information technology services related to a client's software applications portfolio based on historical software applications portfolio data. Still other technical advantages of one or more embodiments of the present invention may include providing an accurate cost estimate of providing information technology services by basing the price estimate on data obtained by the provider during the management stage of a client's historical software applications portfolio.

Certain embodiments may provide all, some, or none of these technical advantages. Certain embodiments may provide one or more other technical advantages, one or more of which may be readily apparent to those skilled in the art from the figures, description, and claims included herein.

### BRIEF DESCRIPTION OF THE DRAWINGS

For a more complete understanding of the present invention and advantages thereof, reference is now made to the following description taken in conjunction with the accompanying drawings, in which:

FIG. 1 is a block diagram of an example estimation system for estimating the feasibility of outsourcing information technology services;

FIG. 2A illustrates example consideration factors, confidence levels, and importance weighting factors used for determining the feasibility of outsourcing information technology services;

FIG. 2B illustrates an example cost solution feasibility index;

FIG. 3 illustrates an example method for estimating the feasibility of outsourcing information technology services; and

FIGS. 4A-4F illustrates the steps of the example method of FIG. 3 in further detail.

### DETAILED DESCRIPTION OF EXAMPLE EMBODIMENTS

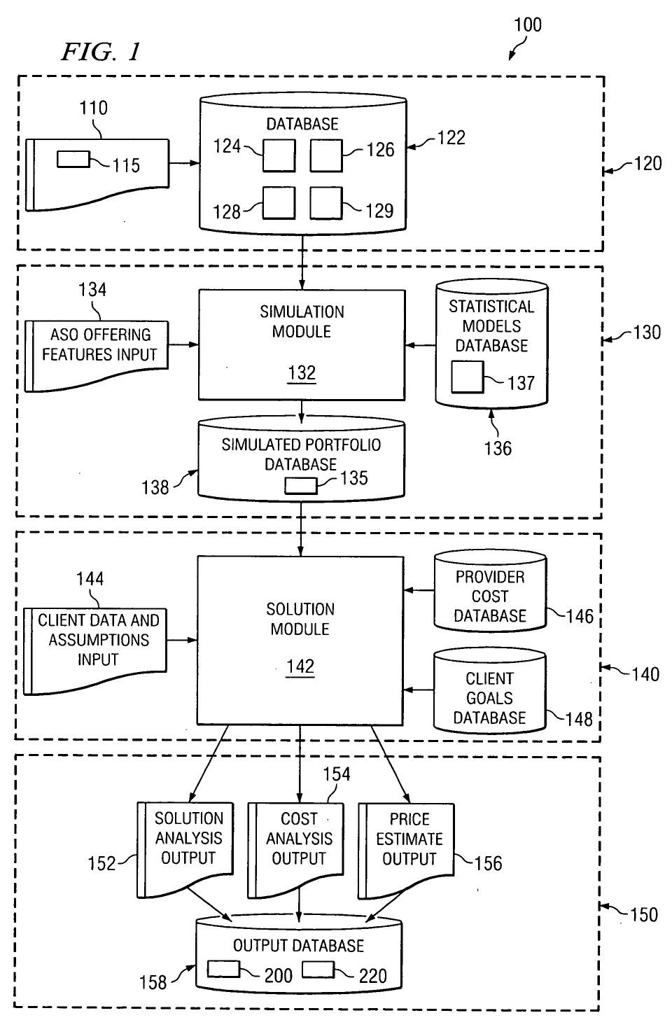

FIG. 1 is a block diagram illustrating an example estimation system 100 for estimating the feasibility of outsourcing information technology (IT) services for a software applications portfolio. A software applications portfolio may comprise any collection of one or more software applications that are in use or are desired to be used by a client, such as a corporation's collection of all of the software applications that are used in its business. System 100 can operate on one or more computers having a database that may include a memory and/or a hard drive and may take the form of volatile or non-volatile memory including, without limitation, magnetic media, optical media, random access memory (RAM), read-only memory or modules (ROM), removable media, or any other suitable local or remote memory component. The memory may include any other suitable data or modules without departing from the scope of this disclosure. A computer having a processor may execute instructions and manipulate data to perform the operations of system 100. The processor may execute any operating system including UNIX, Windows, Linux, and others. The present disclosure contemplates computers other than general-purpose computers, as well as computers without conventional operating systems.

System 100 provides an automated feasibility estimation process that utilizes empirical data to predict the costs of IT outsourcing. In this manner, system 100 proceduralizes IT outsourcing cost prediction, a processes that has traditionally been accomplished on an ad-hoc basis. System 100 may include data preparation sub-system 120, simulation sub-system 130, convergence sub-system 140, and solution sub-system 150. Although specific sub-systems are illustrated, system 100 may comprise any appropriate sub-system or combination of sub-systems capable of estimating the feasibility of outsourcing IT services for a software applications portfolio.

In data preparation sub-system 120, empirical client data 110 is collected and stored in a database 122. Client data may include, for example, information regarding the applications that one or more clients utilized in previous and/or current software applications portfolios (“historical portfolios” 115), the number of lines of computer code (LOC) required to manage and maintain historical portfolios 115, and the number of IT support personnel required to manage and maintain historical portfolios 115. Database 122 may be a repository of information related to various clients or potential clients of the IT outsourcing provider (“provider”). Based on the specific client information of interest in estimating the feasibility of outsourcing IT services from the client to the provider for the software applications portfolio, the associated data may be extracted from the information contained in database 122. During extraction, data associated with client software applications in historical portfolios 115 that meet specific selection criteria, selected by the provider, may be extracted and grouped separately from the other client data. The data associated with software applications in historical portfolios 115 that are concurrently used by more than one client project may be removed from the extraction group. Furthermore, the data associated with client's production support projects that meet the provider's selection criteria may also be extracted.

In certain embodiments, after the client's data has been extracted from the information contained in database 122, the relevant attributes to be included in the IT outsourcing analysis, such as, for example, application size, application quality, application defects, and IT provider team attributes, including, but not limited to, project management, provider experience, and process maturity, are aggregated for each project. The client's extracted applications data may be aggregated by project. For example, in one embodiment, the data associated with a subset of those projects is randomly selected to create a validation dataset 124 statistical models 137 used by simulation sub-system 130. Data associated with subsets of the projects from validation dataset 124 may be randomly selected and aggregated into a validation portfolio 126. Data associated with any remaining projects may then be aggregated into a training dataset 128, which is used to create and train an exploratory set of linear regression statistical models 137 identified using project attributes obtained during the aggregation process described above. The distribution of effort between Application Selective Outsourcing (ASO) features is considered as a class variable to delineate statistical models 137. Industry research and expert knowledge are used to define a data transformation that linearizes the relationship between training dataset 128 and statistical models 137.

Statistical models 137 are implemented by simulation system 130, as discussed below. For each statistical model 137, data associated with subsets of projects may be randomly selected from training dataset 128 and aggregated into a training portfolio 129. In a particular embodiment, statistical models 137 may be validated using the ASO information contained in ASO offering features input 134. ASO offering features input 134 is discussed on more detail below.

After the client's data is aggregated, the data is analyzed using regression analysis to create statistical models 137, which are unbiased using the mean of the residual from the linear regression. Statistical models 137 are validated using validation portfolios 126. Statistical models 137 are built from operational and/or delivery business intelligence of the provider and practical experience information obtained by the provider regarding its clients and/or its potential clients.

Simulation sub-system 130 generates a simulated software applications portfolio (“simulated portfolio”) 135 for the particular client or clients of interest to the provider based on the information associated with historical portfolios 115. Simulation sub-system 130 includes a simulation module 132, ASO offering features input 134, a statistical models database 136, and a simulated portfolio database 138. In some embodiments, simulated portfolio 135 represents the various software applications of historical portfolios 115.

In addition to receiving client data from database 122, simulation module 132 receives input from ASO offering features input 134. ASO offering features input 134 contains information regarding the services supplied by the provider relating to portfolio management and maintenance. For example, ASO offering features input 134 may contain information related to the IT outsourcing services offered by the provider, the cost of those services, the number of employee work hours associated with those services, and the estimated time to complete the services. In some embodiments, simulation module 132 may also retrieve information from statistical models database 136. Statistical models database 136 may include statistical models 137 associated with data that has been extracted, aggregated, and analyzed by data preparation sub-system 120. Simulated portfolios 135 may be stored in simulated portfolio database 138.

Simulated portfolio 135 is utilized by a solution module 142 contained in convergence sub-system 140 to generate various cost solutions/analyses for simulated portfolio 135 to enable a client and/or a provider to determine the feasibility of outsourcing IT services for simulated portfolio 135. Convergence sub-system 140 includes solution module 142, client data and assumptions input 144, a provider cost database 146 and a client goals database 148. Convergence sub-system 140 is capable of integrating various client and provider information, such as the provider's service rates and the client's software portfolio management cost reduction goals, with the simulated portfolio to generate IT outsourcing cost solutions. In some embodiments, the client's IT outsourcing cost solutions are calculated based on the provider's cost estimate of what it would cost the provider to deliver the same resources as the client is already receiving, either through other IT outsourcing arrangements or through the client's internal IT support structure.

Client data and assumptions input 144 includes data that may be entered by either the client or the provider regarding the client's current IT management and maintenance state and assumptions related to the productivity levels of the client's IT resources. The client's current state is an estimate of the client's current required resources to support its current software applications portfolio. For example, client data may include the location of the client and the locations where delivery of the IT services occurs, the number of full-time equivalent employees required to support the client's current software applications portfolio, resource transition requirements (such as whether the client requires its own resources to transition portfolio management and maintenance to the provider) and the skill resource mix of the client's current resources (such as the skill level of the employees managing the client's current software application portfolio).

A second input to solution module 142 is data relating to the billing procedures and cost rules of the provider. This information is contained in provider cost database 146 and may contain empirical data such as the billing rate and/or the number of full-time employees of the provider required to manage and maintain the client's historical portfolios, the cost per one thousand lines of code (KLOC) required to maintain and manage the client's historical portfolios, and the price points for the provider, such as the provider's allowable internal costs and desired profit margin. The provider's billing rates may be used a baseline estimate with the assumption that IT outsourcing rates may vary due to marketplace competition among various potential providers.

In some embodiments, solution module 142 also retrieves information from client goals database 148. Client goals database 148 may include data regarding the client's cost saving goals. For example, this data may include the percentage of savings that the client wishes to achieve over the current cost of managing and maintaining its IT resources, whether those resources are currently supported through IT outsourcing by another provider or through IT support provided by the client itself. In certain embodiments, database 148 may contain “default” industry cost-saving goals for outsourcing the management and maintenance of software applications portfolios.

Based on the data retrieved from client data and assumptions input 144 and databases 138, 146, and 148, solution module 142 creates two cost estimates for the client's IT outsourcing requirements associated with simulated portfolio 135. Cost estimates are generated by applying IT provider resource costs to the estimated level of required IT provider effort relative to the duration of IT outsourcing services and provider skill. The first cost estimate represents the provider's internal cost build-up. In a particular embodiment, the cost build-up estimate integrates the client's current IT resources state, information regarding the general level of productivity of the provider, and the client's estimated cost savings resulting from using the provider's services. The estimated provider's internal cost build-up is calculated based on the ability of the provider to supply cheaper resources than the client can provide for its IT management and maintenance needs, adjusting for a reduction in the number of the client's employees that may be required for the IT support requirements, and adjusting the mix of IT resources required based on employee skill levels. For example, the provider may be able to use less senior employees for the same IT maintenance and management functions than the client is able to use.

The second cost estimate generated by solution module 142 uses simulated portfolio 135 to estimate the client price for the provider's maintenance and management of simulated portfolio 135 during the portfolio management stage. Typically, there are three stages in software portfolio management. The first stage assesses the client's software application portfolio. In the second stage, the client's software application portfolio is transferred from the client to the IT outsourcing provider. In the third stage, the IT outsourcing provider manages the software portfolio for the client. Basing the client price estimate on the management stage of the client's software applications portfolio results in more accurate cost estimates because the IT outsourcing provider has the most control over portfolio management information since it is historical information generally in the possession of the IT outsourcing provider. In a particular embodiment, the client price estimate may be based on the number of lines of code required to manage and maintain simulated portfolio 135 (measured in KLOC), the level of effort required by the provider, and the provider's rates and costing rules data contained in provider cost database 146.

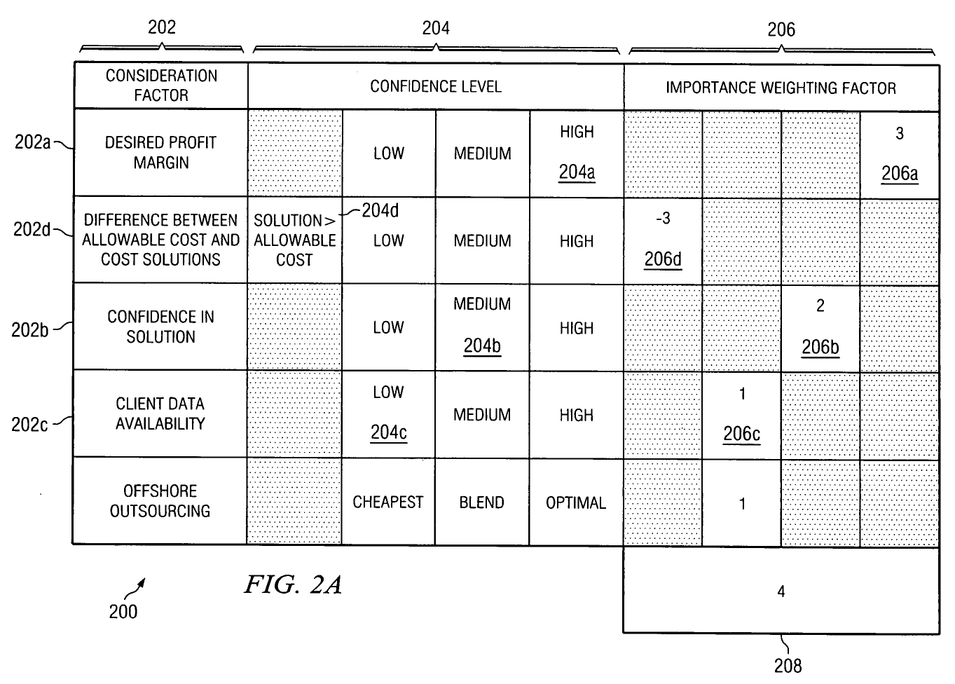

The cost estimates generated by solution module 142 are used in solution sub-system 150 to assess the feasibility of outsourcing IT services associated with simulated portfolio 135. Solution sub-system 150 includes a solution analysis output 152, a cost analysis output 154, a price estimate output 156, and an output database 158. The provider's internal cost build-up estimate and the client price estimate are compared and the solution is analyzed in solution analysis output 152. A provider and/or a client may use solution analysis output 152 to determine if the cost solutions generated by solution module 142 are feasible based upon factors of importance to the provider. For example, solution analysis output 152 may implement various weightings of the factors used by the provider to determine if the cost solutions generated by solution module 142 are viable for the provider based on the desired level of profit that the provider wishes to achieve for providing IT outsourcing services associated with the simulated portfolio. A table of example importance weighting factors is illustrated in FIG. 2A, which is discussed in more detail below.

Referring again to FIG. 1, the estimates generated by solution module 142 are also provided to cost analysis output 154 and price estimate output 156. Cost analysis output 154 contains an itemization of the various costs for the provider to supply IT support to the client for the simulated. Price estimate output 156 contains the estimated pricing point that the provider will charge the client for providing the outsourcing of IT maintenance and management for the simulated portfolio.

Although various modules 132, 142 and databases 122, 136, 138, 146, 148, 158 are show separately, one or more modules and/or databases maybe combined without departing from the scope of the present disclosure.

FIG. 2A illustrates an example table 200 including consideration factors 202, confidence levels 204, and importance weighting factors 206 used for determining the feasibility of outsourcing IT services related to a software applications portfolio. In some embodiments, table 200 may be a look-up table contained in database 158 associated with system 100. Table 200 may include a total importance weighting factor 208, representing the summation of the importance weighting factors 206 associated with each consideration factor 202 for a given level of confidence 204. Consideration factors 202 may include (1) the provider's desired profit margin; (2) the difference between the provider's allowable cost and the cost solutions generated by solution module 142; (3) the provider's confidence in the accuracy of the cost solutions; (4) the availability of client data to the provider; and (5) the cost of providing IT outsourcing offshore, for example, outsourcing to other countries such as India, where lower IT provider costs may be obtained. Although specific consideration factors 202 are illustrated, other factors may be appropriate based on specific circumstances.

Provider confidence levels 204 may contain a qualitative assessment of the provider's confidence in achieving the consideration factors 202. For example, if the provider has a low level of confidence that one or more consideration factors 202 are achievable, then confidence level 204 for the associated factor 202 may be “low.” Similarly, confidence levels 204 for each consideration factor 202 may be “medium,” “high,” or any other appropriate qualitative indicator, based on the specific circumstances of the situation. For example, if consideration factor 202 is the desired profit margin for the provider, illustrated as consideration factor 202a, confidence level 204a associated with consideration factor 202a is “high” if the provider has a high degree of confidence in achieving the desired profit margin. As another example, if consideration factor 202 is the confidence level in a solution, illustrated as consideration factor 202b, confidence level 204b associated with consideration factor 202b is “medium” if the provider has only a medium degree if confidence that that an IT outsourcing solution is achievable. As yet another example, if the provider has a low degree of confidence that data regarding the client's historical portfolios will be available to provider, illustrated as consideration factor 202c, confidence level 204c associated with consideration factor 202c may be “low.” In particular example, if consideration factor 202 is the difference between the allowable cost and the cost solution, illustrated as consideration factor 202d, and the solution costs more than the allowable cost, confidence level 204d may be appropriate, which indicates a lesser level of confidence than a “low” level of confidence.

Importance weighting factors 206 may contain quantitative assessments regarding the importance of consideration factors 202 based on the provider's confidence levels 204. Based on the examples illustrated above, if the provider has a “high” confidence level 204a that the desired profit margin 202a is achievable, an importance weighting factor 206a associated with that level of confidence may be “3.” Similarly, if the provider has a “medium” level of confidence 204b that a solution is achievable, an importance weighting factor 206b associated with that level of confidence may be “2.” In yet another example, if the provider has a “low” level of confidence 204c that client data will be made available to the provider, the importance weighting factor 206c may be “1.” In a particular example, if the cost of the solution is greater than the allowable cost, illustrated as consideration factor 202d with confidence level 204d, importance weighting factor 206d may be negative, such as the “−3”.

Total importance weighting factor 208 represents the summation of each importance weighting factor 206 for each consideration factor 202 based on the determined confidence levels 204. In the illustrated example, the total importance-weighting factor 208 is four.

FIG. 2B illustrates an example cost solution feasibility index 220 used in association with solution analysis output 152 of solution sub-system 150. Index 220 includes three ranges 208a, 208b, 208c of importance weighting factor total 208 for a given cost solution generated by system 100 and their associated levels of provider confidence 210 in the feasibility associated with the cost solution. In the example illustrated in FIG. 2A, the total importance weighting factor 208 is four, which falls in range 208c of FIG. 2B, representing a low level of provider confidence that the cost solution generated by system 100 is feasible. Consequently, the provider may have a low level of confidence that the cost solution for providing IT outsourcing services for a client's software applications portfolio is feasible. In contrast, if the total importance-weighting factor 208 equals twelve, the provider would have a high level of confidence that the cost solution for providing IT outsourcing services for the client's software applications portfolio is feasible. Ranges 208 may have color codes associated with them such that a color code is displayed indicating the feasibility of the cost solutions generated by system 100. For example, range 208a, indicating a high level of confidence in the feasibility of the cost solution, may be green, while ranges 208b and 208c may be yellow and red, respectively. Although example ranges 208a, 208b, 208c are illustrated, any appropriate ranges of total importance weighting factor 208 may be implemented as is appropriate for the specific circumstances.

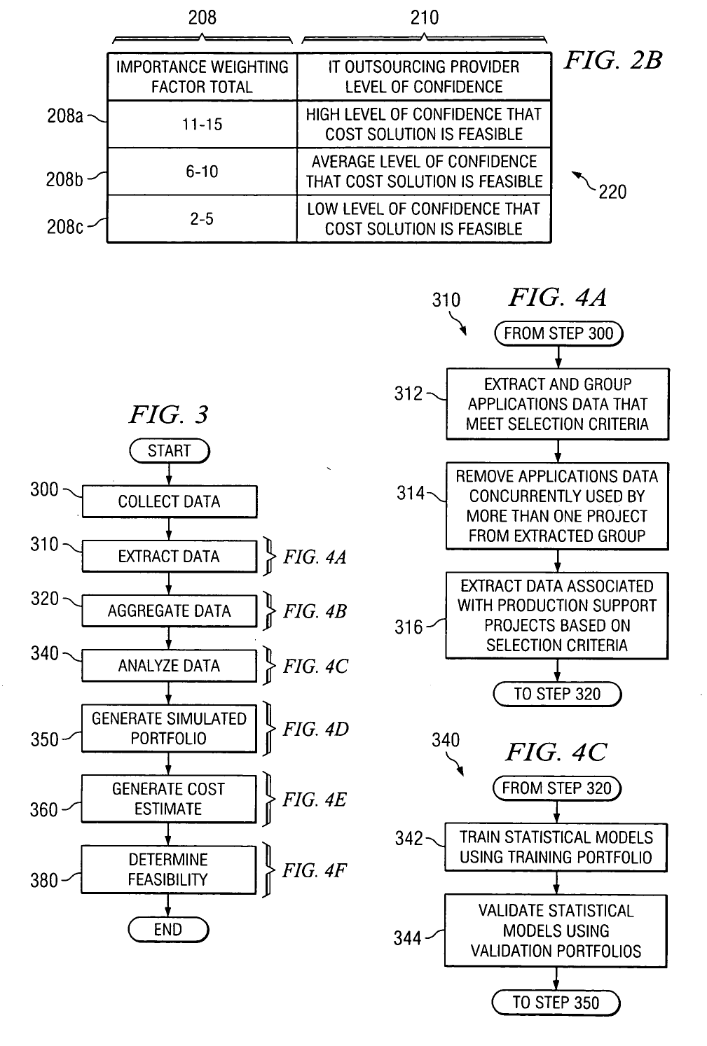

FIG. 3 illustrates an example method for estimating the feasibility of outsourcing IT services for a simulated portfolio 135. The method begins at step 300 where empirical data associated with historical portfolios 115 is collected. As described above, the empirical data may include, for example, information regarding the applications that the client utilized in its historical portfolios, the LOC required to manage and maintain the historical portfolios, and the number of IT support personnel required to manage and maintain the historical portfolios.

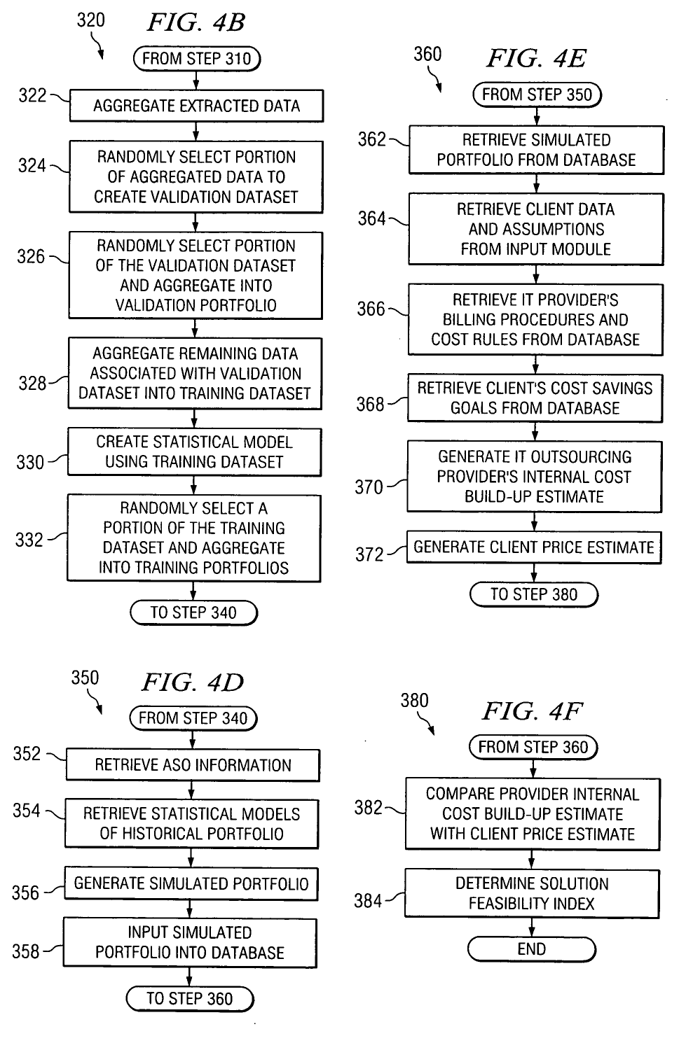

At step 310 of FIG. 4A, data is extracted from database 122. In an example embodiment, step 310 includes sub-steps 312, 314, and 316. At sub-step 312, data associated with the client's software applications contained in historical portfolios 115 that meet specific selection criteria, based on the provider's needs, are extracted and grouped separately from other client data. At sub-step 314, data associated with software applications that are concurrently used by more than one client project are removed from the extraction group. At sub-step 316, data associated with the client's production support projects that meet the provider's selection criteria are also extracted from database 122.

At step 320 of FIG. 4B, the extracted client data is aggregated. In an example embodiment, step 320 includes sub-steps 322, 324, 326, 328, 330, and 332. At sub-step 322, the extracted data are aggregated by project. At sub-step 324, data associated with a subset of those projects is randomly selected to create validation dataset 124 for statistical models 137. At sub-step 326, data associated with subsets of the projects from validation dataset 124 are randomly selected and aggregated into validation portfolios 126. At sub-step 328, any remaining data associated with projects in validation dataset 124 are aggregated into training dataset 128. At sub-step 330, training dataset 128 is used to create statistical models 137 used by simulation system 130. At sub-step 332, data associated with subsets of the projects are randomly selected from training dataset 128 and aggregated into training portfolios 129. Training portfolios 129 include operational and/or delivery business information obtained by the IT outsourcing provider and practical experience information obtained by the IT outsourcing provider regarding its clients and/or its potential clients.

At step 340 of FIG. 4C, the extracted and aggregated client data is analyzed to apply descriptive statistics to correlate the data. In an example embodiment, step 340 includes sub-steps 342 and 344. At sub-step 342, statistical models 137 are trained using training portfolios 129. At sub-step 344, statistical models 137 are validated using validation portfolios 126.

At step 350 of FIG. 4D, a simulated portfolio 135 is generated for the particular client or clients of interest to the provider. In an example embodiment, step 350 includes sub-steps 352, 354, 356, and 358. At sub-step 352, simulation module 132 retrieves ASO information from ASO offering features input 134. As described above, ASO information may include information related to the IT outsourcing services offered by the provider, the cost of those services, the number of employee work hours associated with those services, the estimated time to complete the services, and other information. At sub-step 354, statistical models 137 are retrieved from statistical models database 136. At sub-step 356, simulation module 132 uses the ASO information and statistical models 136 to generate simulated portfolio 135. Simulated portfolio 135 represents the various software applications that the client utilized in historical portfolios 115. At sub-step 358, simulated portfolio 135 is input into simulated portfolio database 138.

At step 360 of FIG. 4E, simulated portfolio 135 and various client and provider data are converged to generate cost estimates of outsourcing a client's IT maintenance and management duties to a provider. In an example embodiment, step 360 includes sub-steps 362, 364, 366, 368, 370, and 372. At sub-step 362, simulated portfolio 135 is retrieved from simulated portfolio database 138.

At sub-step 364, client data and assumptions are retrieved from client data and assumptions input 144. As discussed above, client data and assumptions include information regarding the client's current IT management and maintenance state and assumptions related to the productivity levels of the client's IT resources.

At sub-step 366 the IT provider's billing procedures and cost rules are retrieved from provider cost database 146. As discussed above, this information may include the billing rate and/or the number of full-time employees of the provider required to manage and maintain the client's historical portfolios, the cost per one thousand lines of code (KLOC) required to maintain and manage the client's historical portfolios, and the price points for the provider, such as the provider's allowable internal costs and the provider's desired profit margin. The provider's billing rates may be used a baseline estimate with the assumption that IT outsourcing rates may vary due to marketplace competition among various potential providers.

At sub-step 368, the client's costs savings goals are retrieved from client goals database 148. As discussed above, this data may include the percentage of savings that the client wishes to achieve over the current cost of managing and maintaining its IT resources, whether those resources are currently supported through IT outsourcing by another provider or through IT support provided by the client itself.

At sub-step 370, simulated portfolio 135 is converged with the client's data and assumptions, the provider's billing procedures and cost rules, and the client's cost savings goals to generate an provider cost build-up estimate for the simulated portfolio. The cost build-up estimate integrates the client's current IT resources state, information regarding the general level of productivity of the provider, and the client's estimated cost savings resulting from using provider's services. The estimated provider's internal cost build-up is calculated based on the ability of the provider to provide cheaper resources than the client can provide for its IT management and maintenance needs, adjusting for a reduction in the number of the client's employees that may be required for the IT support requirements, and adjusting the mix of IT resources required based on employee skill levels.

At sub-step 372, simulated portfolio 135 is converged with the client's data and assumptions, the provider's billing procedures and cost rules, and the client's cost savings goals to generate a client price estimate for the outsourcing of IT services to the provider based on the management phase for the simulated portfolio. Basing the client price estimate on the management phase of client's portfolio results in more accurate cost estimates because the provider has the most control over portfolio management information since it is historical information generally in the possession of the provider. Solution module 142 generates the client cost estimate based on the LOC required to manage and maintain the simulated portfolio (measured in thousands of lines of code—KLOC), the level of effort required by the provider, and the provider's rates and costing rules data contained in database 146.

At step 380 of FIG. 4F, the feasibility of outsourcing information services is determined based on the cost estimates generated in step 360. These cost estimates are used in solution sub-system 150 to assess the feasibility of the IT outsourcing cost estimates for both the IT outsourcing provider and the client. In an example embodiment, step 380 includes sub-steps 382 and 384. At sub-step 382, solution analysis output 152 compares the provider's internal cost build-up estimate with the client price estimate for simulated portfolio 135.

At sub-step 384, solution analysis output 152 determines if the cost solutions are feasible by calculating a solution feasibility index 220 based upon consideration factors 202. The solution feasibility index is created by applying provider-assigned importance weighting factors 206 to consideration factors 202 that the provider considers to be relevant to the cost solution analysis based on the level of confidence 204 that the provider has in consideration factors 202. Summing the importance weighting factors 206 for each consideration factor 202 generates a total importance-weighting factor 208. The total importance-weighting factor 208 is then compared to provider-assigned feasibility ranges 208a, 208b, 208c to determine the level of feasibility of the cost solution.

Although an exemplary method is illustrated, the present invention contemplates using any suitable techniques, systems, and/or modules for estimating the feasibility of outsourcing information technology services. For example, many of the steps in FIGS. 3 and 4A-4F may be performed by systems and/or modules other than those described and illustrated. Moreover, many of the steps in FIGS. 3 and 4A-4F may take place simultaneously and/or in different orders than as shown. In addition, the present invention contemplates using methods with additional steps, fewer steps, or different steps, so long as the methods remain appropriate for estimating the feasibility of outsourcing information technology services.

Although the present invention has been described with several embodiments, a multitude of changes, substitutions, variations, alterations, and modifications may be suggested to one skilled in the art, and it is intended that the invention encompass all such changes, substitutions, variations, alterations, and modifications as fall within the spirit and scope of the appended claims.

1. A computer-implemented method for estimating the feasibility of outsourcing information technology services, comprising:
extracting, based on one or more selection criteria, at least a portion of a first set of empirical data associated with one or more software applications in a historical portfolio, the historical portfolio containing software applications utilized by a client;
aggregating at least a portion of the extracted data;
creating a statistical model of the historical portfolio based on the first set of data;
generating a simulated portfolio based at least in part on the statistical model;
generating a cost estimate associated with outsourcing technology services based at least in part on the simulated portfolio and a second set of data, at least a portion of the second set of data containing empirical data, the empirical data containing data and assumptions relating to the historical portfolio; and
determining the feasibility of outsourcing technology services based at least in part on the cost estimate.

2. The method of claim 1, wherein extracting at least a portion of the first set of data further comprises:
grouping the extracted data based on the one or more selection criteria;
removing, from the extracted group, the extracted data concurrently used by more than one project; and
extracting data associated with production support projects based on the one or more selection criteria.

3. The method of claim 1, further comprising:
comprising randomly selecting at least a portion of the aggregated data to create a validation dataset;
randomly selecting at least a portion of the validation dataset; and
aggregating the randomly selected portion of the validation dataset to create a validation portfolio, the validation portfolio being used to validate the statistical model of the historical portfolio.

4. The method of claim 1, further comprising:
creating a training dataset from at least a portion of the aggregated data, the training dataset used to create the statistical model of the historical portfolio;
randomly selecting at least a portion of the training dataset to create a training portfolio; and
training the statistical model using the training portfolio.

5. The method of claim 1, further comprising analyzing the aggregated data, wherein analyzing comprises applying descriptive statistics to correlate the aggregated data.

6. The method of claim 1, further comprising retrieving application selective offering (ASO) information, the ASO information containing information regarding the services provided by a provider relating to the management and maintenance of a software applications portfolio, the ASO information and the statistical model being used to generate the simulated portfolio.

7. The method of claim 1, wherein the second set of data comprises data and assumptions related to a client, billing procedures, and cost rules related to a provider, and cost savings information related to the client.

8. The method of claim 7, wherein the cost savings information contains default industry cost savings goals.

9. The method of claim 1, wherein generating a cost estimate comprises generating a provider cost build-up estimate associated with the simulated portfolio.

10. The method of claim 1, wherein generating a cost estimate comprises generating a client price estimate associated with the simulated portfolio.

11. The method of claim 1, wherein determining the feasibility of outsourcing information technology services comprises:
calculating a solution feasibility index associated with the cost estimate; and
comparing the index to one or more feasibility ranges.

12. Software for estimating the feasibility of outsourcing information technology services, the software embodied in a computer readable medium and comprising computer code such that when executed is operable to:
extract, based on one or more selection criteria, at least a portion of a first set of empirical data associated with one or more software applications in a historical portfolio, the historical portfolio containing software applications utilized by a client;
aggregate at least a portion of the extracted data;
create a statistical model of the historical portfolio based on the first set of data;
generate a simulated portfolio based at least in part on the statistical model;
generate a cost estimate associated with outsourcing technology services based at least in part on the simulated portfolio and a second set of data, at least a portion of the second set of data containing empirical data, the empirical data containing data and assumptions relating to the historical portfolio; and
determine the feasibility of outsourcing technology services based at least in part on the cost estimate.

13. The software of claim 12, wherein the code is further operable to:
group the extracted data based on the one or more selection criteria;
remove, from the extracted group, the extracted data concurrently used by more than one project; and
extract data associated with production support projects based on the one or more selection criteria.

14. The software of claim 12, wherein the code is further operable to:
randomly select at least a portion of the aggregated data to create a validation dataset;
randomly select at least a portion of the validation dataset; and
aggregate the randomly selected portion of the validation dataset to create a validation portfolio, the validation portfolio being used to validate the statistical model of the historical portfolio.

15. The software of claim 12, wherein the code is further operable to:
create a training dataset from at least a portion of the aggregated data, the training dataset used to create the statistical model of the historical portfolio;
randomly select at least a portion of the training dataset to create a training portfolio; and
train the statistical model using the training portfolio.

16. The software of claim 12, wherein the code is further operable to analyze the aggregated data by applying descriptive statistics to correlate the aggregated data.

17. The software of claim 12, wherein the code is further operable to retrieve application selective offering (ASO) information, the ASO information containing information regarding the services provided by a provider relating to the management and maintenance of a software applications portfolio, the ASO information and the statistical model being used to generate the simulated portfolio.

18. The software of claim 12, wherein the second set of data comprises data and assumptions related to a client, billing procedures, and cost rules related to a provider, and cost savings information related to the client.

19. The software of claim 18, wherein the cost savings information contains default industry cost savings goals.

20. The software of claim 12, wherein the code is further operable to generate a cost estimate by generating a provider cost build-up estimate associated with the simulated portfolio.

21. The software of claim 12, wherein the code is further operable to generate a cost estimate by generating a client price estimate associated with the simulated portfolio.

22. The software of claim 12, wherein the code is further operable to determine the feasibility of outsourcing technology services by:
calculating a feasibility solution index associated with the cost estimate; and
comparing the index to provider-assigned feasibility ranges.
